(19) United States
(12) Patent Application Publication
(10) Pub. No.: US 2012/0089510 A1
(43) Pub. Date: Apr. 12, 2012

(54) Fee Management System

(76) Inventors: Jeremy Martin Peyer, Eden Prairie, MN (US); Joshua James Vandebogert, St. Louis Park, MN (US); Ryan Robert Fox, Minneapolis, MN (US)

(21) Appl. No.: 13/326,262

(22) Filed: Dec. 14, 2011

Related U.S. Application Data
(63) Continuation-in-part of application No. 12/070,137, filed on Feb. 15, 2008.
(60) Provisional application No. 60/936,203, filed on Jun. 19, 2007.

(51) Int. Cl. G06Q 20/22

(52) U.S. Cl. 705/40

(57) ABSTRACT

A system is taught for out-sourced management of educational institution fee arrangements that reduces the contacts with a responsible party of a student during the finalization of fee payment arrangements to a single contact. Specifically, the invention includes a system that includes an apparatus configures to provide a single personalized communication with a responsible party. The single communication includes a third party fee management contract and an educational institution payment contract.

### CROSS REFERENCE TO RELATED APPLICATIONS

This application is a continuation in part of application Ser. No. 12/070,137 filed Feb. 15, 2008 that claims the benefit of PPA Appl. No. 60/936,203 filed Jun. 19, 2007, all by Jeremy Martin Peyer, Joshua James Vandebogert and Ryan Robert Fox.

### FIELD OF THE INVENTION

This invention relates to third party management of educational institution tuition or fee payments by responsible parties.

### BACKGROUND OF THE INVENTION

There is a need to simplify the process that responsible parties use to finalize fee payment plans of educational institutions that are managed by third parties. Currently multiple contacts with responsible parties are necessary to establish these arrangement.

Fees sought by educational institutes from persons responsible for costs associated with the attendance of a student come in many forms and often are reduced by grants, by financial aid awards, and by other discounts. Many educational institutions are either too small to efficiently manage fee payments by responsible parties or are not interested in personally managing the fee payments due institutional priorities. In an effort to reduce costs, such institutions increasingly are using third parties that specialize in these activities to handle such arrangements. However, this practice has resulted in a responsible party receiving multiple mailings to finalize the arrangements. One mailing from the institution notifies the party of the tuition award and seeks a contract of payment obligation between the institution and the party. Then a second mailing that details selected payment arrangements is sent from the institution that seeks a contract between the third party fee management entity and the responsible party. The potential for confusion and missed deadlines increases where a responsible party has more than one individual applying to more than one educational institution.

Efforts by others have not solved this problem. Some have focused on computer programs that allow a student to track various sources of funding. Others have taught online systems for private educational institutions to determine fee payments.

There is still a need for a method and system that minimizes the contacts made to responsible parties during the finalization of fee payment arrangements.

### SUMMARY OF THE INVENTION

We have invented a system, method and apparatus for out-sourced management of educational institution fee arrangements that reduce the contacts with a responsible party of a student during the finalization of fee payment arrangements to a single contact. Specifically, we have invented a system that includes an electronic apparatus configured to provide out-sourced management of educational institution fee arrangements that comprise a single personalized communication with a responsible party. The single communication includes a third party fee management contract to pay net fees due an educational institution and an educational institution payment contract. Optionally, the single communication also includes a personalized fee notification. The third party fee management entity does not make or arrange others to make loans for a responsible party for attendance to an educational institution by a student. The net fees do not include loan payments.

We have also invented a method that includes providing a single personalized communication with a responsible party. The single communication comprises a third party fee management contract and an educational institution payment contract.

Further, we have invented an apparatus that includes a computing device configured to be able to receive and manipulate educational institution fee data and data about a prospective student to provide a single personalized communication with a responsible party. The communication comprises a third party fee management contract and an educational institution payment contract. No loan payments are included in the communications.

As used herein:

“Educational institution” means an institution that seeks payment of “fees” from a “responsible party” to itself through a “third party fee management entity”.

“Educational institution payment contract” means an agreement between a “responsible party” and an “educational institution” for payment of “fees” described in “fee notification” in exchange for attendance at the educational institution by a student.

“Fees” means the net fee that is calculated from at least one of a group of factors comprising a base fee, a base tuition, costs for activities, costs for books, costs of usage of facilities and equipment, grants, multiple enrollment discounts and financial aid awards but does not include loans.

“Fee notification” means a communication to one of the “responsible party”, the student, or an address provided on an application regarding the attendance at the “educational institution” by the student that includes the net fee sought by the “educational institution” for attendance by the student where the “net fee” comprises a base fee and applicable discounts but does not include loans.

“Responsible party” means person(s) responsible for payment of fees and (1) may be responsible for multiple students if the “responsible party” is parent and several minor children are accepted to school (2) may be multiple persons if two or more persons are responsible, and (3) may be the student if the student is responsible for tuition.

“Single personalized communication” means the initial transmission of at least a “third party fee management contract” and an “educational institution payment contract” to one of the “responsible party”, the student, or an address provided on an application regarding the attendance at the “educational institution” by the student

“Third party fee management contract” means an agreement between a “responsible party” and a “third party fee management entity” that includes a name and contact information for the “responsible party”, a selected payment plan and payment method, and, optionally, a third party processing fee.

“Third party fee management entity” means an entity that manages the payment of a net fee due an educational institution by a “responsible party” according to agreed payment times and method and does not make educational assistance loans or assist a responsible party in selecting lenders for an educational assistance loan.

Our invention benefits the responsible party arranging for fee payments to a third party fee payment management entity by reducing the number of mailings needed to finalize plans. The acceptance of a student to an educational institution and the payment arrangements for fees can be a stressful time for an increasing number of responsible parties. This is aggravated by occasions when more than one student is involved or when more than one educational institution is being approached. Our invention reduces the number of times a responsible party is contacted to finalize fee payment arrangements. This reduces stress on both the responsible parties and the students, and minimizes possible confusion from multiple mailings.

### BRIEF DESCRIPTION OF THE DRAWINGS

One or more features or preferred forms of the invention are described in the accompanying drawings. The drawings are briefly described below.

FIG. 1 is a schematic of an embodiment of the system of our invention.

FIG. 2 is a flow diagram showing an embodiment of the method of our invention.

FIG. 3 is a flow diagram showing a typical method in current use by educational institutions that use fee management entities.

FIG. 4 is a schematic of an embodiment of the apparatus of our invention.

### DETAILED DESCRIPTION OF SOME EMBODIMENTS OF THE INVENTION

For the purposes of this document, an educational institution is one that requires a fee for a student to attend some aspect of what is offered by the institution. It may be private or public and may be referred to interchangeably in this document as educational institution or institution.

Educational institutions are under increasing pressures to manage costs and refocus energies on core activities that further education. As a result, more institutions that charge students some form of fees are turning to a third party fee management entity to manage the collection of the fees.

Many private educational institutions have used third party fee management entities for a while. This is particularly true when the institutions are small or are unmotivated to spend the time necessary for the task that can be quite complex.

In recent years, public educational institutions are beginning to consider using third party fee management entities for various reasons as the institutions are passing more and more charges on to students for such things as participation in sports, band, choir, field trips and a growing number of other extra-curricular activities.

Fees can be quite complex. The calculations can be involved and highly individualistic. Then the notifications and attainment of necessary contracts can be time-consuming. In addition, the plans may be modified during the life of the contracts as fee-based services are either added or deleted, where deletion is available. Finally, the collection of fees, often on a periodic program and with a variety of methods, may be tedious and distract from the mission of an educational institution.

Typically, fees mean net fees and include gross or base fees less various discounts. Base fees are costs to students for attending an institution and include, for example, such items as a base tuition (for private institutions), costs for activities, costs for books and costs of usage of facilities and equipment to arrive at a gross fee. This fee is reduced by a variety of discounts including, for example, multiple student discounts, grants, scholarships, and other financial aid awards to arrive at a net fee or fee. Educational loans are not involved in the calculation of these fees.

Once fees are determined, the institution sends several communications to the student or to a responsible party, if known, to solidify payment obligations. If the communications go to a student, they generally are passed on to the responsible party. Contracts are then with the responsible party.

The responsible party is one or more person(s) who assume responsibility for payment of the fees. The responsible party may be responsible for multiple students in cases, for example, where the responsible party is a parent and several minor children are accepted to a particular educational institution that requires fee payment. In addition, the responsible party may be multiple persons if two or more persons are responsible. In addition, the responsible party may be the student where the student is personally responsible for fees and has the financial resources to pay the fees.

A third party fee management entity is an entity that manages the payment of a net fee due an educational institution by a responsible party according to agreed payment times and method. Generally, a responsible party contracts separately with a third party fee management entity for a payment plan selected by the party. Payment plans may be those that involve one payment or payments over a specified time. Payment plans typically include method of payment, such as, by check, money order, credit card or other. Also, a processing fee is often added to the fees by the management entity. A fee management entity is not a lender and does not offer loans to a responsible party or receive loan payments from a responsible party.

For the purposes of this document, an educational institution is one that requires a fee for attendance by a student. The payment of the fee is to come from a responsible party through a third party fee management entity. The educational institution may be private or public and may be referred interchangeably in this document as an educational institution or institution.

Various communications presently occur to finalize fee arrangements. One is a fee notification. The fee notification typically is sent to the address listed on an application for the student to attend an institution. This notice informs what the fee is and offers various payment plans, sometimes for additional fees.

A second communication is an educational institution payment contract. This is an agreement between the responsible party and an educational institution for payment of fees described in the fee notification in exchange for attendance by a student. This contract may be modified or supplemented if the student desires additional fee-based activities during the term of the original contract.

A third communication is a third party fee management contract. This is an agreement between the responsible party and a third party fee management entity. It typically includes a name and contact information for the responsible party, a selected payment plan and payment method, and, optionally, a third party processing fee. The responsible party contracts to make payments to the third party fee management entity and the third party fee management entity makes fee payments to the educational institution.

Presently, the third communication is sent separately to a responsible party from the other two. This increases the anxiety on the part of a responsible party and may cause some confusion where multiple institutions and multiple students are involved.

In addition to providing benefits to the responsibility party, others benefit as well from our invention. The institution accomplishes necessary communications more efficiently and less expensively. Also, the student has a more concise transmission from the institution where the student is interested in financial arrangements. As family budgets are becoming more strained, students are often forced to become more conscious of costs despite their interests.

One embodiment of our invention is a system for out-sourced management of educational institution fee arrangements. The system includes an electronic apparatus configured to provide out-sourced management of educational institution fee arrangements that comprise a single personalized communication with a responsible party. The system allows the third party fee management entity to transmit in a single communication at least two communications to the responsible party, the student, or an address provided on an application regarding the attendance at the educational institution by the student. The single communication includes the third party fee management contract and the educational institution payment contract.

In this document, a single personalized communication means the initial transmission of at least the third party fee management contract and the educational institution payment contract to one of the responsible party, the student, or an address provided on an application regarding the attendance at the educational institution by the student. In some embodiments of our invention, the single communication includes the fee notification transmitted to a responsible party. Current industry practice is to use a communication process that involves several communications to convey the information obligating the responsible party to the institution and to the third party fee management entity.

Currently the communication process typically involves a system that includes multiple distinct steps, communications, and databases. In one step, a third party fee management entity provides a blank third party fee management contract form to an educational institution that is using the services of the fee management entity. In a second step, the educational institution reviews such items as enrollment data, tuition, fees, discounts and aid awards for each student to create a fee notification, also called an award notification. In a third step the educational institution sends to a responsible party, or caretaker of record, of the student's payment obligation the fee notification listing the net payment that is due for the services provided by the educational institution. This first communication to a responsible party often is accompanied with an educational institution payment contract proposal. The proposal is meant to contractually obligate the educational institution and the responsible party for payment in exchange for services such as, for example, tuition payment for specified attendance at the institution when signed by the responsible party. This contract proposal often contains various payment options such as, for example, payment of the entire obligation at one time or payment in installments over various periods of time and numbers of payments.

After the first communication to the responsible party, other steps occur that end in another communication. In a fourth step, the responsible party completes the contract form by signing the contract, selecting the payment plan option desired, and returning the contract proposal to the institution. In a fifth step, the institution uses this proposal to finalize the payment plan of each student, including preparing a personalized third party fee management contract form from a blank form presently provided by a third party fee management entity. In a sixth step, the educational institution sends a second communication to the responsible party containing the personalized third party fee management contract.

After the second communication to the responsible party, still other steps usually occur before arrangements are finalized. In a seventh step, the responsible party completes the fee management contract by a selecting payment option plan including frequency and method of payment, signing the contract form and sending it back to the educational institution. Usually the fee management contract includes a fee paid to the third party entity for fee management services. In an eighth step, the institution retains a copy of the signed third party fee management contract and sends a copy to the third party management entity to begin the process of managing fee payments by the third party entity.

Our invention is unique to institutions and fee management entities. To accomplish the present practice, at least two databases from two different entities are needed to generate the multiple personalized communications to a responsible party that ends in fee management by a third party entity. The educational institution has a database that is capable of generating necessary notifications and contract forms after a series of several communications with a responsible party. Then a database of the third party fee management entity is used to create a process of managing fee payments from the responsible party by the third party management entity. In addition, there is minimal communication between an educational institution and a third party fee management entity until the institution supply the management entity with the information necessary to create by the management entity a personalized process of managing fee payments from a responsible party. Thus, single communications are currently not known.

As stated above, our system reduces the communications made to a responsible party to create a personalized fee maintenance process to a single communication. The system includes an electronic data storage device configured to include a database, an electronic document creation device configured to create personalized notification and contract forms, and an electronic transmission device configured to transmit a single communication regarding fees. In the first element, the database contains sufficient data on the fee arrangements by the educational institution on at least one student and data on the student to allow the generation of a third party fee management contract and an educational institution payment contract. This may be presently available to some third party entities but not recognized by them or their institution clients as being useful to generate single communications.

The second element, the electronic document creation device, is in interactive communication with the database of the electronic data storage device and is configured to generate several personalized forms. These forms include at least a third party fee management contract and an educational institution payment contract. The creation device is configured to be able to consider frequency and method of payment, processing fees, and net fees due educational institution by a responsible party. One embodiment is configured to have an interactive program able to selectively abstract relevant data from the database and create personalized communications that are sent to a responsible party including the three discussed above. This can be done by known programming techniques once the database is available and the need to create a single communication is recognized.

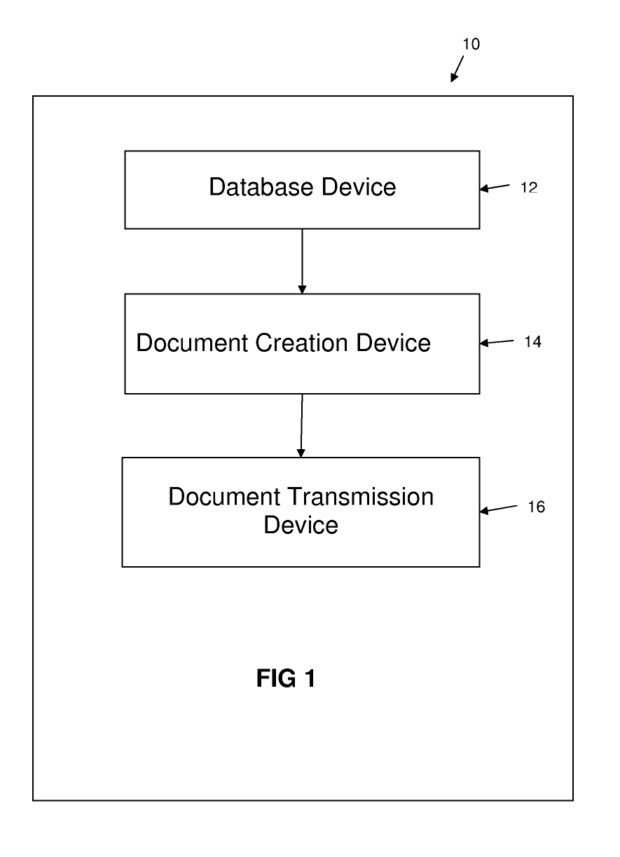

The third element is an electronic transmission device configured to transmit the single communication to an address provided by a student or responsible party. This transmission device is in communication with the document creation device to obtain the relevant personalized communications to be transmitted. This communication is generally electronic in nature. The embodiments of the transmission device include any device that is configures to transmit the forms to the recipient by any means, including mail, email, telegram, or facsimile. One embodiment generates enveloped communication material for conveyance by such means as, for example, by various mailing services. Another embodiment is configured to convey communication by internet access with secured procedures. The common feature is that the communication includes at least a third party fee management contract and an educational institution payment contract. FIG. 1 is a schematic of an embodiment of the system of our invention. A system (10) includes an apparatus comprising a database (12) with the above-described configuration, an apparatus for creating personalized documents (14) as described above, and an apparatus for transmitting the documents (16) in a single personalized communication to a responsible party.

Another embodiment of our invention is a method. The method is one of providing an out-sourced electronic apparatus and sending a personalized communication to a responsible party. The electronic apparatus is administered by a non-lending and non-educational third-party fee management entity that does not arrange loans for a responsible party or provide lenders for loans by the responsible party for attendance to an educational institution by a student. The apparatus is configured to generate a single personalized communication with the responsible party. The single communication comprises at least a third party fee management contract and an educational institution payment contract to one of the responsible party, the student, or an address provided on an application regarding the attendance at the educational institution by the student.

The sending step of the method includes three steps. The first step is to provide a necessary database to create the personalized communications. The database contains sufficient data on the fee arrangements of the educational institution for at least one student, data on the student, and date on fee management procedures to be able to generate a third party fee management contract and an educational institution payment contract. This often requires institutions to provide information that they have in the past kept internal.

The second step is to create personalized forms. These forms include a third party fee management contract and an educational institution payment contract. Details describing how this is done are discussed above.

The third step is to transmit a single communication to obligate by contracts a responsible party to both the institution and the fee management entity. The communication including the third party fee management contract and the educational institution payment contract is conveyed to an address provided by the student or responsible party. Communication may be by either electronic or material conveyance as previously described.

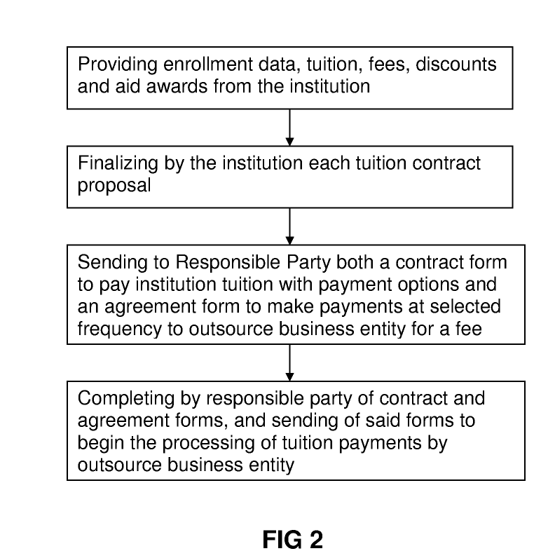

An embodiment of the method includes the four steps shown in FIG. 2. The first step includes providing enrollment data, tuition, fees, discounts and aid awards from the school. The enrolment date includes at least a student name, but may also include grade, student identification number and/or other contact or identification information. Tuition often is calculated by credit hour, grade, or other method that is useful to the institution. In the second step, the institution finalizes the tuition contract of each student.

The third and fourth steps involve the single personalized communication. In the third step, the responsible party receives both the institutional payment contract form and the fee management contract. The institutional contract is to obligate the responsible party to pay the institution the net school tuition and typically includes various payment options offered by the institution. The fee management contract form is to obligate the responsible party to make payments at a selected frequency to the third party fee management entity. This latter often includes a fee to the entity for its services. However, optionally, the institution may pay the fee. In the fourth step, the two contracts are completed by the responsible party and conveyed to either the entity or the institution, or both. If the signed forms are conveyed to either the entity or the institution, then the receiving organization communicates the necessary evidence of obligation to the other.

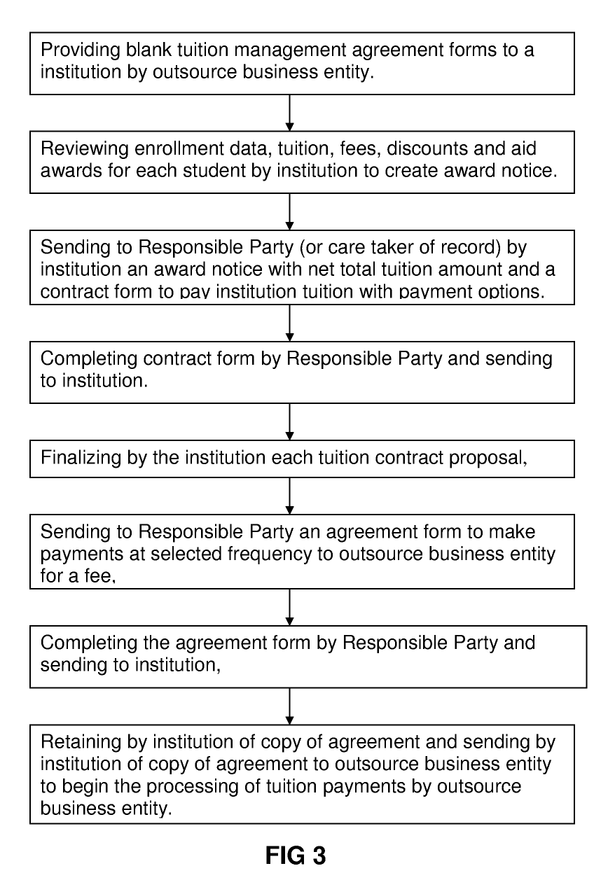

In contrast, the present method of transmitting this information is more convoluted. It typically includes the eight steps shown in FIG. 3. First, blank tuition management contract forms are provided to the educational institution by the third party fee management entity. Second, to create an award notice, the institution reviews enrollment data, tuition, fees, discounts and aid awards for each student. Third, the institution sends the responsible party (or caretaker of record) a first communication that contains an award notice with net total tuition amount and a contract form to pay school tuition with payment options. Fourth, the responsible party completes the contract and sends it to the institution. Fifth, the institution finalizes each student contract and enters student information into the blank fee management form. Sixth, the institution sends to the responsible party a second communication that contains a personalized contract form to make payments at selected frequency to a third party fee management entity for a fee. Seventh, the responsible party completes the fee management contract form and sends it to the institution. Finally, the institution retains a copy of the fee management contract and sends a copy to the fee management entity to enter in its system to be able to process tuition payments.

Still another embodiment of our invention is an apparatus for out-sourced management of educational institution fee arrangements. This apparatus includes a computing device properly configures to result in the single fee-related communication to a responsible party that has been discussed above. Specifically, the computing device is configured to be able to receive and manipulate educational institution fee data and data about a prospective student to provide a single personalized communication with a responsible party. The communication comprises the third party fee management contract and the educational institution payment contract discussed above.

The configurations of the computing device include the following three elements, an electronic data storage device configured to include a database, an electronic data manipulation device configured to create documents and an electronic data transfer device configured to transmit a single communication relating to fees. In the first element, the database contains sufficient data on the fee arrangements of the educational institution for at least one student and data on the student to be able to generate at least a third party fee management contract and an educational institution payment contract.

The second element, a data manipulation device, is configured to create personalized forms that comprise at least the third party fee management contract and the educational institution payment contract. This device is in interactive communication with the data storage device to be able to create personalized fee-related documents suitable for mailing to responsible parties of persons desiring participation in fee-based activities of the educational institution.

The third element, an electronic data transfer device, is configured to transmit fee-related documents in a single communication to an address provided by a student or responsible party. The data transfer device is in interactive communication with the data storage device and the data manipulation device and is configured to be able to convey a single communication comprising the third party fee management contract and the educational institution payment contract. The data transferring devices are well known and may be designed for electronic or material communication. Electronic devices include, for example, those that communicate by the internet or other electronic communication systems. Material devices include, for example, printers that produce paper documents that are subsequently conveyed by U.S. Mail, facsimile, or other delivery channels.

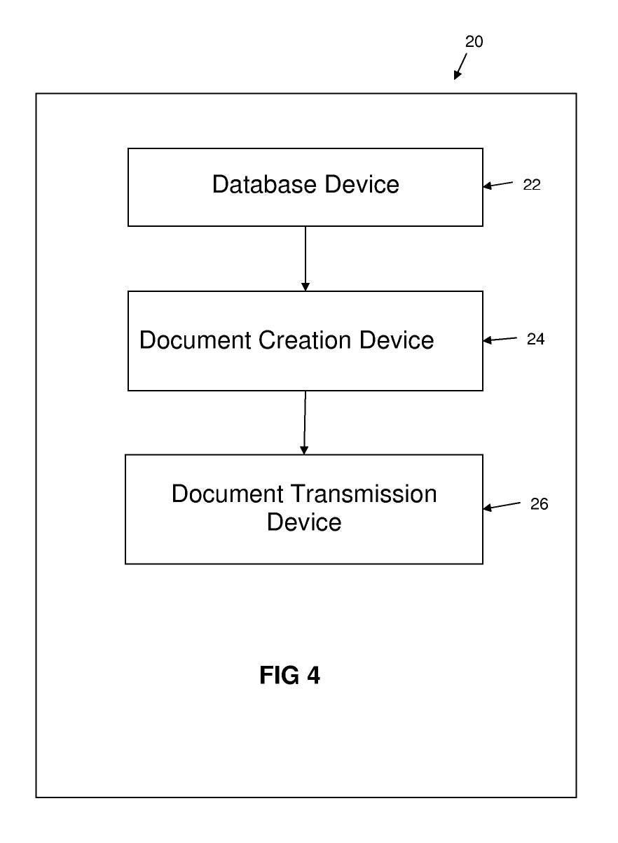

FIG. 4 is a schematic of an embodiment of the apparatus of our invention. An apparatus (20) includes an apparatus comprising a database (22) with the above-described configuration, an apparatus configured to create personalized documents (24) as described above, and an apparatus for transmitting the documents (26) in a single personalized communication to a responsible party.

The data storage device comprising the database and the data transfer device are presently known in parts for other applications. The data manipulation device for creating personalized communications was created by us to interact with the database and data transferring device to accomplish the goal of a single communication as defined above. Surprisingly, this was not done before. Apparently, institutions have not had the means to create third party fee payment contracts because that is why they hire third party fee management entities. Third party fee management entities have not had the ability to create fee notifications or institution payment contracts because of lack of access to the relevant information from the institution or lack of appreciation of the benefits to the responsible party or motivation to create the benefit.

Other embodiments will be apparent to those skilled in the art. This document is meant to include all embodiments that encompass the spirit and purpose of the invention.

We claim:

1. A system for out-sourced management of educational institution fee arrangements, comprising,
an electronic apparatus configured to provide out-sourced management of educational institution fee arrangements that comprise a single personalized communication with a responsible party, and
the single personalized communication comprises
a third party fee management contract between a third party fee management entity and the responsible party to accept payment terms of educational institution net fees to the third party in exchange for payment of the net fees by the third party fee management entity to the educational institution and
an educational institution payment contract between the responsible party and the educational institution for payment of the net fees to the third party fee management entity in exchange for attendance at the educational institution by the student,
wherein the third party fee management entity does not make or arrange others to make loans for a responsible party for attendance to an educational institution by a student and
wherein the net fees do not include loans.

2. The system of claim 1 wherein the third party fee management contract comprises a name and contact information for the responsible party, a selected payment plan and payment method, and a third party processing fee.

3. The system of claim 1 wherein the educational institution payment contract comprises a contract to attend the institution and a contract to pay fees described in the fee notification.

4. The system of claim 3 wherein the educational institution payment contracts may be amended by parties during a term of the educational institution payment contract.

5. The system of claim 1 wherein the educational institution is an institution that seeks payment of fees from the responsible party to the third party fee notification entity.

6. The system of claim 1 wherein the single personalized communication is from the educational institution or the third party.

7. The system of claim 1 wherein the single personalized communication further comprises a fee notification and the fee notification does not include any loans.

8. The system of claim 7 wherein the fee notification comprises the net amount sought by the educational institution for attendance by the student and the net amount comprising a base fee and applicable discounts.

9. The system of claim 8 wherein the net amount is calculated from at least one of a group of factors consisting of a base fee, a base tuition, costs for activities, costs for books, costs of usage of facilities and equipment, grants, multiple enrollment discounts and financial aid awards that do not include any loans.

10. The system of claim 1 wherein the electronic apparatus, comprises,
an electronic data storage device configured to include a database with sufficient data about the fee arrangement of the educational institution for at least a student and other data about the student to allow the generation of at least two personalized documents comprising a third party fee management contract and an educational institution payment contract,
an electronic document creation device in interactive communication with the electronic device configured with the data base and configured to create the at least two personalized documents, said personalized documents comprising at least a third party fee management contract and an educational institution payment contract, and
an electronic transmission device in interactive communication with the electronic document creation device and configured to transmit a single personalized communication to an address provided by a student or a responsible party, the single personalized communication comprising at least two personalized documents comprising a third party fee management contract and an educational institution payment contract.

11. The system of claim 10 wherein the database received final data from the educational institution regarding a student fee proposal before the at least two personalized documents are created and a single transmission is conveyed.

12. The system of claim 10 wherein the electronic device for transmitting is configured to create a material mailing to the responsible party, the student or an address provided on an application regarding an attendance at the educational institution by the student and the mailing comprises at least the two personalized documents.

13. The system of claim 10 wherein the electronic device for transmitting a single communication is in communication with an internet site, that is in communication with the electronic device configured to create the at least two personalized documents and to be accessible through an electronic link by use of a secure procedure, and the electronic device for transmitting a single communication is configured to convey the link to the responsible party, the student or an address provided on an application so that the at least two personalized documents that relate to an attendance at the educational institution by the student are able to be downloaded securely from the internet site.

14. A method for out-sourced management of educational institution fee arrangements, comprising,
providing an out-sourced electronic apparatus that is (1) administered by a non-lending and non-educational third-party fee management entity that does not arrange loans for a responsible party or provide lenders for loans to the responsible party for attendance to an educational institution by a student and (2) configured to generate a single personalized communication with the responsible party, said communication comprising
a third party fee management contract between the third party fee management entity and the responsible party to accept payment terms of educational institution net fees to the third party fee management entity in exchange for payment of the net fees by the third party fee management entity to the educational institution and
an educational institution payment contract between the responsible party and the educational institution for payment of the net fees to the third party fee management entity in exchange for attendance at the educational institution by the student and
sending the single communication to the responsible party.

15. The method of claim 14 wherein sending the single communication, comprises the steps of,
providing an out-sourced electronic device configured with a database containing sufficient data on the fee arrangements of the educational institution for at least a student and other data on the student to be able to generate at least two personalized documents comprising the third party fee management contract and the educational institution payment contract,
creating personalized documents with a device configured to create the at least two personalized documents and that is in active communication with the database device, and
transmitting with a communication device in active communication with the creation device a single communication to an address provided by a student or responsible party, said communication comprising the at least two personalized documents.

16. The method of claim 14 wherein the single personalized communication further comprises a fee notification.

17. The method of claim 15 wherein transmitting is through an electronic communication device configured to create a material mailing to the responsible party, the student or an address provided on an application regarding the attendance at the educational institution by the student and the mailing comprises at least the two personalized documents.

18. The method of claim 15 wherein transmitting is through the electronic device for transmitting a single communication, the transmitting device is in communication with an internet site that is in communication with the electronic device configured to create the at least two personalized documents and that is accessible through an electronic link by use of a secure procedure conveyed to the responsible party, the student or an address provided on an application regarding an attendance at the educational institution by the student so that the at least two personalized documents that relate to an attendance at the educational institution by the student are able to be downloaded securely from the internet site.

19. An apparatus for out-sourced management of educational institution fee arrangements, comprising,
a computing device configured to receive and manipulate personal fee data of an educational institution and personal data about at least one prospective student of the educational institution to provide a single personalized communication to a responsible party, the personalized communication comprising
a third party fee management contract between a third party fee management entity and the responsible party to accept payment terms of educational institution net fees to the third party fee management entity in exchange for payment of the net fees by the third party fee management entity to the educational institution and
an educational institution payment contract between the responsible party and the educational institution for payment of the net fees to the third party fee management entity in exchange for attendance at the educational institution by the student,
wherein the third party fee management entity does not make or arrange others to make loans for a responsible party for attendance to an educational institution by a student and
wherein the net fees contain no loan payments.

20. The apparatus of claim 19 wherein the computing device, comprises,
an electronic data storing device configured to include a database with sufficient personalized data on the third party the fee arrangement of the educational institution for at least a student and other personalized data on the student sufficient to generate the single personalized communication comprising the third party fee management contract and the educational institution payment contract,
an electronic data manipulating device in interactive communication with the data storing electronic device and configured to create the single personalized communication comprising at least a third party fee management contract and an educational institution payment contract, and
an electronic transmitting device in interactive communication with the electronic data manipulating device and configured to transmit the single communication to an address provided by a student or responsible party.
